(19) United States
(12) Patent Application Publication
(10) Pub. No.: US 2009/0296926 A1
(43) Pub. Date: Dec. 3, 2009

(54) KEY MANAGEMENT USING DERIVED KEYS

(75) Inventor: Radia J. Perlman, Sammamish, WA (US)

Correspondence Address: PVF -- SUN MICROSYSTEMS INC.;C/O PARK, VAUGHAN & FLEMING LLP, 2820 FIFTH STREET, DAVIS, CA, 95618-7759, US

(73) Assignee: SUN MICROSYSTEMS, INC., Santa Clara, CA (US)

(21) Appl. No.: 12/131,525

(22) Filed: Jun. 2, 2008

(51) Int. Cl. H04L 9/28

(52) U.S. Cl. 380/44

(57) ABSTRACT

Some embodiments of the present invention provide a system that generates and retrieves a key derived from a master key. During operation, the system receives a request at a key manager to generate a new key, or to retrieve an existing key. To generate a new key, the system generates a key identifier and then derives the new key by cryptographically combining the generated key identifier with the master key. To retrieve an existing key, the system obtains a key identifier for the existing key from the request and then cryptographically combines the obtained key identifier with the master key to produce the existing key.

### BACKGROUND

1. Field

The present invention generally relates to techniques for managing keys which are used to encrypt and/or decrypt data. More specifically, the present invention relates to a key manager that uses derived keys to facilitate efficient key management.

2. Related Art

In order to protect sensitive data from unauthorized access, organizations commonly store sensitive data in encrypted form. Hence, if the encrypted data needs to be accessed, it must first be decrypted using a key. However, such keys can, over time, be obtained by an adversary through compromise or coercion.

To remedy this problem, such keys can be stored in a remote key-management server (KMS), which makes it much harder to covertly discover the keys. For example, a standard key-management strategy (for instance, in a tape drive system which manages encrypted tapes) is to provide a KMS that maintains a database of (key ID, key) pairs. A key ID can then be stored as metadata on the tape along with the associated encrypted data. When the encrypted data needs to be decrypted, the key ID can be sent by the tape drive to the KMS, which uses the key ID to look up and return the associated key from a database of keys located at the KMS. However, this database can be large because encryption keys are typically large (for example, hundreds or even thousands of bits). Moreover, this database is updated frequently, which makes it hard to synchronize the database among multiple KMS replicas (if the system maintains multiple KMS replicas).

In an alternative technique, the system stores metadata along with the encrypted data, wherein the metadata includes the key K encrypted with a master key S (represented as “{K}S”) and a master key ID. To obtain K, the tape drive sends the master key ID and {K}S to the KMS. The KMS then uses the master key ID to look up the master key S in a set of master keys maintained by the KMS, and then uses S to decrypt and return K. The problem with this technique is that it requires a larger data structure in the metadata to store {K}S, because {K}S must be the size of a key, whereas a key ID can be much shorter than a key and hence requires less space.

Hence, what is needed is a technique for managing keys without the above-described problems.

### SUMMARY

Some embodiments of the present invention provide a system that generates a derived key. During operation, the system receives a request for a key at a key manager, wherein the request includes a key identifier for the key. Next, the system obtains a master key which is maintained by the key manager. The system then cryptographically combines the key identifier with the master key to generate the derived key, and returns the derived key to a requestor.

In some embodiments, the request also includes a master-key identifier, which identifies the master key. In this embodiment, the system obtains the master key by using the master-key identifier to look up the master key in a set of master keys maintained by the key manager.

In some embodiments, after the derived key is returned to the requester, the requester uses the derived key to encrypt or decrypt a data item.

In some embodiments, prior to sending the request to the key manager, the requester generates the request by: obtaining the key identifier and the master-key identifier from metadata associated with an encrypted data item, and including the key identifier and the master-key identifier in the request.

In some embodiments, cryptographically combining the master key with the key can involve: hashing the master key with the key identifier; or encrypting the key identifier with the master key.

In some embodiments, the key identifier is cryptographically combined with the master key to produce a seed, and the seed is used as an input to a key generator which generates the derived key.

In some embodiments, the key generator generates a cryptographic key pair, which includes a private-key and a public-key.

In some embodiments, system receives a new-key request at the key manager. In response to the new-key request, the system generates a new-key identifier for the new key. Next, the system obtains a master key and cryptographically combines the new-key identifier with the master key to generate the new key. Finally, the system returns the new key and the new-key identifier to the requester.

In some embodiments, generating the new-key identifier involves incrementing a next-identifier counter and using the incremented value from the next-identifier counter as the new-key identifier.

In some embodiments, generating the new-key identifier involves generating the new-key identifier randomly using a random number generator.

### BRIEF DESCRIPTION OF THE FIGURES

FIG. 1 illustrates a client-server system in accordance with an embodiment of the present invention.

FIG. 2 presents a flow chart illustrating how a request for a key is generated and how the resulting key is used in accordance with an embodiment of the present invention.

FIG. 3 presents a flow chart illustrating how a key is derived from a master key in accordance with an embodiment of the present invention.

FIG. 4 presents a flow chart illustrating how a new key and a corresponding new-key identifier are generated in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### System

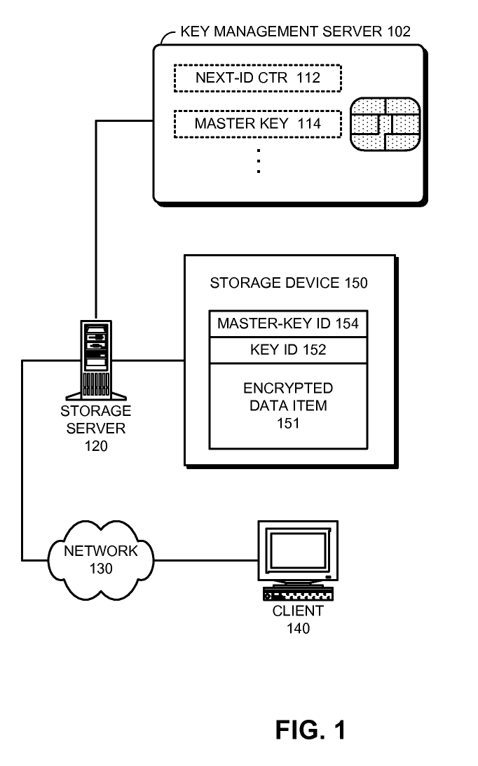

FIG. 1 illustrates a system that uses a key-management server 102 (also referred to as a “key manager”) in accordance with an embodiment of the present invention. More specifically, the system includes a key-management server (KMS) 102 which is coupled to a storage server 120, which coordinates accesses to a storage device 150 in accordance with an embodiment of the present invention. During operation, storage server 120 services data-access requests (received from client 140 over network 130) to access data on storage device 150.

Note that KMS 102 can include any type of system that can manage keys. Moreover, KMS 102 can be implemented on any type of computer system or computing device, including, but not limited to, a computer system based on a microprocessor, a mainframe computer, a digital signal processor, a portable computing device, a personal organizer, a device controller, and a computational engine within an appliance. Hence, KMS 102 is not meant to be limited to a key-management server which is implemented on a smart card as is illustrated in FIG. 1.

Storage server 120 can include any computational node including a mechanism for servicing requests from client 140 to access data on storage device 150. In general, storage server 120 can be implemented on any type of computer system or computing device, including, but not limited to, a computer system based on a microprocessor, a mainframe computer, a digital signal processor, a portable computing device, a personal organizer, a device controller, and a computational engine within an appliance.

Storage device 150 can include any type of non-volatile (or possibly volatile) storage device that can be coupled to a computer system. This includes, but is not limited to, magnetic, optical, or magneto-optical storage devices, as well as storage devices based on flash memory and/or battery-backed up memory.

Storage device 150 can store one or more data items. For example, as illustrated in FIG. 1, storage device 150 can store an encrypted data item 151 along with associated metadata. This metadata includes a master-key identifier (master-key ID) 154, which identifies a specific master key on KMS 102. It also includes a key identifier (key ID) 152, which identifies a specific “derived key” which is derived from the identified master key.

Network 130 can generally include any type of wired or wireless communication channel capable of coupling together computing nodes. This includes, but is not limited to, a local area network, a wide area network, or a combination of networks. In one embodiment of the present invention, network 130 includes the Internet.

Client 140 can generally include any node on a network including computational capability and including a mechanism for communicating across the network.

During operation, storage server 120 services data-access requests from client 140 to access data on storage device 150. While servicing these requests, storage server 120 makes requests to KMS 102 to provide one or more keys to encrypt or decrypt data items which are stored on storage device 150.

Referring to FIG. 1, KMS 102 maintains a number of data items, including a next-identifier counter (Next-ID Ctr) 112 which is used to allocate unique sequential identifiers for keys. KMS 102 also maintains one or more master keys, including master key 114. These master keys can be used to generate “derived keys” as is described in more detail below.

### Generating a Request

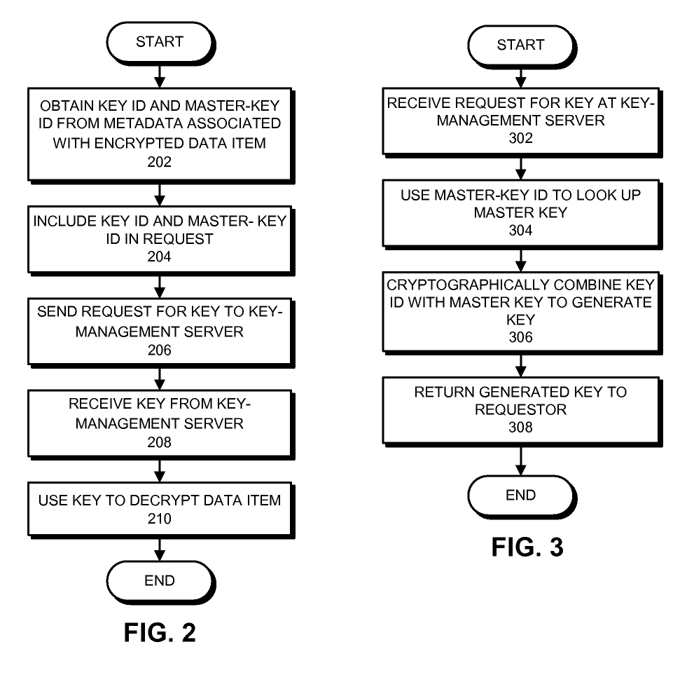

FIG. 2 presents a flow chart illustrating how a request for a key is generated and how the resulting key is used in accordance with an embodiment of the present invention. First, the system obtains a key identifier and a master-key identifier from metadata associated with an encrypted data item (step 202). For example, referring to FIG. 1, storage server 120 can retrieve master-key ID 154 and key ID 152 from metadata associated with encrypted data item 151. Next, storage server 120 includes the master-key ID 154 and the key ID 152 in a request for a key (step 204), and sends the request to KMS 102 (step 206). KMS 102 then generates and returns a key using the steps described below with reference to FIG. 3. Finally, storage server 120 receives the key from KMS 102 (step 208) and then uses the key for some purpose, such as decrypting a data item (step 210).

### Generating a Derived Key

FIG. 3 presents a flow chart illustrating how a key is derived from a master key in accordance with an embodiment of the present invention. At the start of this process, KMS 102 receives a request for a key from storage server 120, wherein the request includes master-key ID 154 and key ID 152 (step 302). KMS 102 then uses master-key ID 154 to look up master key 114 in a set of one or more master keys stored on KMS 102 (step 304).

Next, KMS 102 cryptographically combines master key 114 with key ID 152 to produce a derived key (step 306). Note that KMS 102 can combine key ID 152 and master key 114 in a number of ways. For example, KMS 102 can hash master key 114 with the key ID 152, using a hash function, such as MD5. Alternatively, KMS 102 can encrypt key ID 152 with the master key 114 using any one of a number of possible encryption functions.

In further embodiments, key ID 152 is cryptographically combined with master key 114 to produce a seed, and the seed is used as an input to a key generator which generates the key which is not simply a random number, but instead has a specific property or structure. For example, the key generator can generate a cryptographic key pair, which includes a private-key and a public-key.

Finally, KMS 102 returns the derived key to the requester (step 308).

### Generating a New Key and a New-Key Identifier

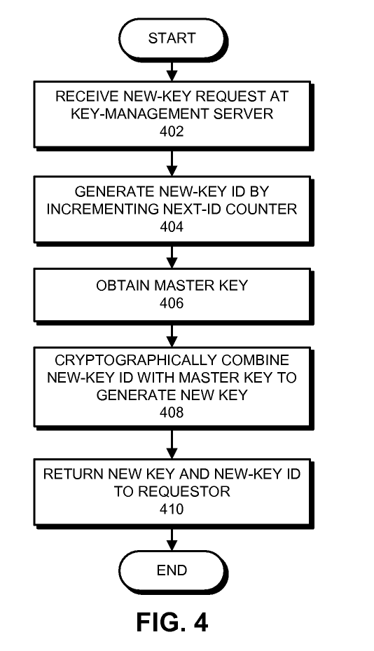

FIG. 4 presents a flow chart illustrating how a new key and a corresponding new-key identifier are generated in accordance with an embodiment of the present invention. At the start of this process, KMS 102 receives a new-key request from storage server 120 (step 402).

In response to this new-key request, KMS 102 generates a new-key identifier for the new key (step 404). In general, KMS 102 can use any technique which can generate an unused new-key identifier. For example, KMS 102 can increment next-identifier counter 112 and can use the incremented value as the new-key identifier. Alternatively, KMS 102 can use a random-number generator to randomly generate the new-key identifier. Note that if the new-key identifier is generated randomly, it is desirable to use a long random number (for example, 64 bits in length) as the new-key identifier to make the probability of generating a duplicate new-key identifier extremely low.

Next, the system obtains a master key 114 (step 406). In one embodiment, this involves using a master-key ID (which is received along with the new-key ID request) to look up master key 114 in a set of master keys stored on KMS 102.

The system then cryptographically combines the new-key identifier with the master key to generate the new key (step 408).

Finally, the system returns the new key and the new-key identifier to the requester (step 410).

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A method for generating a key, comprising:
receiving a request for a key at a key manager, wherein the request includes a key identifier for the key;
obtaining a master key which is maintained by the key manager;
cryptographically combining the key identifier with the master key to generate the key; and
returning the generated key to a requestor.

2. The method of claim 1,
wherein the request also includes a master-key identifier, which identifies the master key; and
wherein obtaining the master key involves using the master-key identifier to look up the master key in a set of master keys maintained by the key manager.

3. The method of claim 2,
wherein prior to receiving the request at the key manager, the method further comprises sending the request from the requester to the key manager; and
wherein after the key is returned to the requestor, the key is used to encrypt or decrypt a data item.

4. The method of claim 3, wherein prior to sending the request from the requester to the key manager, the method further comprises generating the request by:
obtaining the key identifier and the master-key identifier from metadata associated with an encrypted data item, which was encrypted using the key; and
including the key identifier and the master-key identifier in the request.

5. The method of claim 1, wherein cryptographically combining the master key with the key involves:
hashing the master key with the key identifier; or
encrypting the key identifier with the master key.

6. The method of claim 1, wherein the key identifier is cryptographically combined with the master key to produce a seed, and the seed is used as an input to a key generator which generates the key.

7. The method of claim 6, wherein the key generator generates a cryptographic key pair, which includes a private-key and a public-key.

8. The method of claim 1, wherein the method further comprises:
receiving a new-key request at the key manager;
in response to the new-key request,
generating a new-key identifier for the new key,
obtaining a master key,
cryptographically combining the new-key identifier with the master key to generate the new key,
returning the new key and the new key identifier to the requester.

9. The method of claim 8,
wherein the new-key request also includes a master-key identifier, which identifies the master key; and
wherein obtaining the master key involves using the master-key identifier to look up the master key in a set of master keys maintained by the key manager.

10. The method of claim 8, wherein generating the new-key identifier involves:
using a random number generator to generate the new-key identifier;
incrementing a next-identifier counter and using the incremented value from the next-identifier counter as the new-key identifier; or
selecting an unused new-key identifier.

11. A computer-readable storage medium storing instructions that when executed by a computer cause the computer to perform a method for generating a key, the method comprising:
receiving a request for a key at a key manager, wherein the request includes a key identifier for the key;
obtaining a master key which is maintained by the key manager;
cryptographically combining the key identifier with the master key to generate the key; and
returning the generated key to a requestor.

12. The computer-readable storage medium of claim 11,
wherein the request also includes a master-key identifier, which identifies the master key; and
wherein obtaining the master key involves using the master-key identifier to look up the master key in a set of master keys maintained by the key manager.

13. The computer-readable storage medium of claim 12,
wherein prior to receiving the request at the key manager, the method further comprises sending the request from the requester to the key manager; and
wherein after the key is returned to the requestor, the key is used to encrypt or decrypt a data item.

14. The computer-readable storage medium of claim 13, wherein prior to sending the request from the requestor to the key manager, the method further comprises generating the request by:
obtaining the key identifier and the master-key identifier from metadata associated with an encrypted data item, which was encrypted using the key; and
including the key identifier and the master-key identifier in the request.

15. The computer-readable storage medium of claim 11, wherein cryptographically combining the master key with the key involves:
hashing the master key with the key identifier; or
encrypting the key identifier with the master key.

16. The computer-readable storage medium of claim 11, wherein the key identifier is cryptographically combined with the master key to produce a seed, and the seed is used as an input to a key generator which generates the key.

17. The computer-readable storage medium of claim 16, wherein the key generator generates a cryptographic key pair, which includes a private-key and a public-key.

18. The computer-readable storage medium of claim 11, wherein the method further comprises:
receiving a new-key request at the key manager;
in response to the new-key request,
generating a new-key identifier for the new key,
obtaining a master key,
cryptographically combining the new-key identifier with the master key to generate the new key,
returning the new key and the new key identifier to the requester.

19. The computer-readable storage medium of claim 18,
wherein the new-key request also includes a master-key identifier, which identifies the master key; and
wherein obtaining the master key involves using the master-key identifier to look up the master key in a set of master keys maintained by the key manager.

20. The computer-readable storage medium of claim 18, wherein generating the new-key identifier involves:
using a random number generator to generate the new-key identifier;
incrementing a next-identifier counter and using the incremented value from the next-identifier counter as the new-key identifier; or
selecting an unused new-key identifier.

21. An apparatus that generates a key, comprising a key manager, wherein the key manager is configured to:
receive a request for a key, wherein the request includes a key identifier for the key;
obtain a master key;
cryptographically combine the key identifier with the master key to generate the key; and
return the generated key to a requester.
